(19) United States
(12) Patent Application Publication
(10) Pub. No.: US 2024/0383818 A1
(43) Pub. Date: Nov. 21, 2024

(54) DISPERSIBLE SEED MEAL PARTICLES

(71) Applicant: The Andersons Inc., Maumee, OH (US)

(72) Inventors: Anthony Lee Goldsby, Maumee, OH (US); Michael Rainey-Smithback, Maumee, OH (US)

(73) Assignee: The Andersons Inc., Maumee, OH (US)

(21) Appl. No.: 18/661,580

(22) Filed: May 11, 2024

Related U.S. Application Data
(60) Provisional application No. 63/466,782, filed on May 16, 2023.

(51) Int. Cl. C05F 5/00; A01N 25/12; A01P 17/00; C05D 9/02; C05F 11/08; C05G 3/40; C05G 3/80; C05G 5/12; C05G 5/40; C09K 17/16

(52) U.S. Cl. CPC C05F 5/002; A01N 25/12; A01P 17/00; C05D 9/02; C05F 11/08; C05G 3/40; C05G 3/80; C05G 5/12; C05G 5/40; C09K 17/16

(57) ABSTRACT

A water-dispersible particle is provided to disperse additive agents and substances that repel specific species such as round worms or fish, function in bioremediation, or a combination thereof. The dispersible particles are used to treat soil or bodies of water. Exemplary uses include turf management, soil reclamation, and aquaculture. A water-dispersible particle for delivery of granulated seed meal is provided. In exemplary form, granulated camellia seed is delivered in the form of dispersible particles. A method for making and using the water-dispersible particle is also provided. The durable particle retains size and shape during handling and application to a desired area and dissolves or crumbles into small particles upon contact with water or a water overspray within twelve hours thereby facilitating controlled release and distribution of the additive agents and substances to the target including granulated seeds, nitrogen, and optional agents including plant nutrients, pesticides, hormones, herbicides, and micronutrients.

### RELATED APPLICATIONS

This application claims priority benefit of U.S. Provisional Application Ser. No. 63/466,782 filed on May 16, 2023, the contents of which are hereby incorporated by reference.

### FIELD OF THE INVENTION

The present invention relates to water-dispersible particles for delivery of biomolecules. More particularly, the present invention relates to water-dispersible granulated seed meal particles in pellet form for delivery of biomolecules.

### BACKGROUND OF THE INVENTION

A continuing problem in care of large areas of cultivated vegetation is the difficulty of delivery of an agent such as a plant nutrient, fertilizer, a pest irritant, or a pesticide to the target. A practical and labor-saving approach to agent delivery in areas such as golf courses, parks, lawns, gardens, and woodlands has been broadcast application of granular products containing an agent, for example via rotary spreader. Using granular products having particle sizes in the range of about 0.3 millimeter to about 10 millimeters, an operator can cover a large area with minimal distance traversed by the spreader itself, while applying the granular products relatively uniformly to the desired area. Unfortunately, such granular products often remain in solid or semisolid form several days following their application. This solid or semisolid form retention is a problem when the granular product is carrying an additive ingredient such as pesticides, pest irritants, plant growth regulators, micronutrients, or plant growth regulators because these substances remain physically bound up with the granule so that their efficacy is reduced or delayed. This can result in loss of the additive ingredient via volatilization and photodegradation with the consequence of lower efficacy and higher cost.

A further consequence of the fact that granular products often remain in solid or semisolid form for long periods following application is that the granules are subject to removal by cultural practices such as mowing with clipping removal, leaf and or yard waste vacuuming; or run-off from weather events, especially on sloping ground where the underlying soils have low percolation rates; where the ground cover is closely mown or relatively thin and sparse; and where the equipment or pedestrians traffic is high. This causes a loss of the uniformity of the biological response sought by the use of the product. In addition, product efficacy may be altered due to excessive concentration of the product within the areas treated.

The long persistence of the granular products also results in a greater likelihood that people and or animals may come into physical contact with the granules, which may result in skin irritation, sensitization, dermal absorption, and toxicity. Additionally, when clothing, footwear and equipment come into physical contact with the granules, they can cause damage, corrosion or staining.

Previous attempts to spread granulated seed powders have proven difficult to spread on to target surfaces including golf courses, as the seed powder tends to clump and not uniformly disperse from a mechanical spreader. Furthermore, extruded pellets typically require large quantities of water to disperse and days to even months to disperse.

Camellia (Camellia sinensis), an annual herbaceous plant, is one of the most widely used and well-documented medicinal plants in the world and the leaves constitute tea consumed throughout the world. Camellia contains phenolic compounds such as the saponin, flavonoids apigenin, quercetin, patuletin and luteolin, glucosides and coumarins (herniarin and umbelliferone) (Mann, Staba, Craker and Simon, Recent Advances in Botany, Horticulture, and Pharmacology.” Phoenix, AR, USA: Oryx Pres (1986).; Mckay & Blumberg, Phytotherapy Research: An International Journal Devoted to Pharmacological and Toxicological Evaluation of Natural Product Derivatives 20.8 (2006): 619-633). Mustard seed meal and hot pepper also appear to have similar activity.

Studies have provided evidence that camellia extracts have significant impact on adult H. contortus, observed in terms of worm paralysis and/or death at different post-treatment intervals at even low concentrations. Previous studies revealed that R. ulmifolius exhibited significant activity at the same concentrations (Akkari, Hajaji, B'chir, Rekik and Gharbi, Veterinary Parasitology 221 (2016): 46-53); meanwhile, A. campestris and T. capitatus were additive at lower concentrations (100% inhibition at 2 mg/ml) (Boubaker Elandolsi et al., 2013; Akkari et al., (Akkari, Rtibi, B'chir, Rekik, Darghouth and Gharbi, Veterinary Research Communications 38 (2014): 249-255). There is also effectiveness in repelling earthworms as a means of greens management (Potter, Redmond, and Williams, International Turfgrass Society Research Journal, 12 (2013) 347-356.; and Managing Earthworm Casts on Golf Courses, Oct. 7, 2022; Green Section Staff, USGA.org).

Based on these results, a significant linear positive correlation between total polyphenols, flavonoids, and tannin contents and vermicidal activity was observed. Akkari et al. (Akkari, Hajaji, B'chir, Rekik and Gharbi, Veterinary Parasitology 221 (2016): 46-53) reported the same result with Rubus extracts. Many hypotheses have been proposed to explain the antiparasitic activity of these compounds, which are known to interfere with energy generation in parasites by uncoupling oxidative phosphorylation (Athanasiadou, Kyriazakis, Jackson and Coop, Veterinary parasitology 99.3 (2001): 205-219). The strong correlation between anti-oxidant and antiparasitic activity of camellia can be explained by its rich flavonoid content. Interestingly, it has been suggested that anti-oxidant flavonoids might have anthelmintic activity (Ferreira, Reference Ferreira2011) and anti-oxidant levels are also an indicator of flavonoids that can potentiate commercial anthelmintics.

Tannins are known for their protein-binding ability, which can protect proteins from degradation in the rumen, and increase protein flow to the small intestine and amino acid absorption (Min, Barry, Attwood and McNabb Animal feed science and technology 106.1-4 (2003): 3-19). The antiparasitic activity on adults can be explained by their contact with the nematode's cuticle, buccal cavity, oesophagus and reproductive tract (Hoste, Martínez-Ortiz-De-Montellano, Manolaraki, Brunet, Ojeda-Robertos, Fourquaux, Torres-Acosta and Sandoval-Castro, Veterinary parasitology 186.1-2 (2012). Moreover, polyphenolic compounds might interfere with enzymes secreted or excreted by the worms in the local environment, or with enzymes involved in metabolic pathways that are essential for nematode functions (Athanasiadou, Kyriazakis, Jackson and Coop, Veterinary parasitology 99.3 (2001): 205-219).

As noted above, attempts to spread granulated seed powders have proven difficult to spread on to target surfaces including golf courses, as the seed powder tends to clump and not uniformly disperse from a mechanical spreader. Furthermore, as previously noted, extruded pellets typically require large quantities of water to disperse and require days to months to disperse.

Thus, there is a continuing need for a uniformly sized, durable product in particle form which can deliver granulated seed meals in a controlled release manner and whose components are quickly dispersible in order to provide even delivery of additive agents to target plants and organisms over a large area. There further exists a need to co-administer therewith additional nutrients or other agents to limit the labor of caring for the target plant growing plots or bodies of water.

### SUMMARY OF THE INVENTION

A water-dispersible particle is provided that includes a granulated seed meal, a binder component, present in an amount ranging from 1% to 95% by weight of the total dry weight of the particle. The particle has a mean particle domain size, where the seed meal and the binder component are present in a form such that contact with water causes particle dispersion into more than 100 pieces in a time period of up to 24 hours. In specific embodiments the water-dispersible particle further includes one or more of biochar, microbes, a bioavailable fertilizer, a micronutrient, or a combination thereof. In specific embodiments the water-dispersible particle further includes an additive ingredient that is a soil nutrient of: calcium, magnesium, sulfur, iron, manganese, copper, zinc; oxides thereof; salts thereof; or a combination thereof. In specific embodiments the additive ingredient is a natural organic product of: humic acid, blood meal, bone meal, seed meal, feather meal, soy meal, meat meal, animal waste, activated sludge, hydrolyzed animal hair, a fish byproduct, chitin, composts, or a combination thereof. In specific embodiments the additive seed meal is camellia seed meal, and may further include an additional material of one or more of mustard seed meal, cayenne pepper, or saponin. In a specific embodiment the additive seed meal is mustard seed meal.

A water-dispersible particle is provided that includes a granulated camellia seed meal. The granulated camellia seed meal is present in an amount ranging from 5% to 99% by weight of the total dry weight of the particle, alone or in combination with biochar, as well as a binder component, present in an amount ranging from 1% to 95% by weight of the total dry weight of the particle. The particle has a mean particle domain size, where the granulated camellia seed is present in a form such that contact with water causes particle dispersion into more than 100 pieces in a time period of up to 24 hours. In specific embodiments the water-dispersible particle further includes one or more of biochar, microbes, a chelating agent, or a micronutrient. In specific embodiments the water-dispersible particle further includes a soil nutrient selected from the group consisting of: calcium, magnesium, sulfur, iron, manganese, copper, zinc; oxides thereof; salts thereof, and a combination thereof.

A method is provided for repelling round worms from turf. The method includes broadcasting water-dispersible particles as described herein on or around a perimeter of the turf, and exposing the particles to water in an amount sufficient to induce dispersion of the particles to constituent granules, the granules repelling the round worms from the turf.

A method of bioremediation is provided. The method includes broadcasting particles as described herein on soil or aquatic silt containing a contaminant, exposing the particles to water in an amount sufficient to induce dispersion of the particles to constituent granules to inhibit sequestration of the contaminant, and treating the soil or aquatic silt to concentrate the contaminant. The treating portion of the method includes at least one of: applying a chelating agent, microbes, or growing Boehmeria nivnea in proximity to the contaminant.

### BRIEF DESCRIPTION OF THE DRAWING

The subject matter that is regarded as the invention is particularly pointed out and distinctly claimed in the claims at the conclusion of the specification. The foregoing and other objects, features, and advantages of the invention are apparent from the following detailed description taken in conjunction with the accompanying drawing in which:

FIG. 1 is a plot showing a linear relationship between dose of biochar/saponin combination and earthworm mortality in accordance with embodiments of the invention;

FIG. 2 is a comparative bar graph showing moss infestation percentage at study start, 4.5 months, and 9 months for untreated control and for quicksilver, Comparative Ex. A, and Comparative Ex. B formulations; and

FIG. 3 is a line graph of moss infestation percentage at study start and at 14 day intervals during the period of the study from July 10 to October 13 for untreated control and for quicksilver, Comparative Ex. A, and Comparative Ex. B formulations.

### DETAILED DESCRIPTION OF THE INVENTION

The present invention has utility to efficiently disperse additive substances that repel specific species such as round worms or fish, function in bioremediation, or a combination thereof. The inventive dispersible particles are used to treat soil or bodies of water. Exemplary uses include turf management, soil reclamation, and aquaculture. A water-dispersible particle for delivery of granulated seed meal is provided. In exemplary form, granulated camellia seed is delivered in the form of dispersible particles. The invention further relates to a method for making and using the water-dispersible particle. The inventive particle retains its size and shape during handling and application to a desired area and dissolves or crumbles into small particles upon contact with a water overspray within twelve hours. Thus, the durability of the particle allows delivery of the particle to the vicinity of the desired site of action whereupon contact with water sufficient to wet the particle surface causes dispersion of particle components, facilitating distribution of the additive agents to the target. The term dispersion in the context of the present invention is intended to mean that an inventive particle disperses by breaking into numerous smaller pieces upon contact with water. In a preferred embodiment, an inventive particle disperses by breaking up into greater than 100 smaller pieces upon contact with water over a period of time ranging from 1 second to 24 hours. Preferably, an inventive particle disperses into 1,000 to 10,000 smaller pieces over a period of time ranging from 1 second to 12 hours. Even more preferably, a particle disperses into 100 to 10,000 smaller pieces over a period of 30 seconds to 6 hours. Most preferably, a particle disperses as described over a period of 1 minute to 1 hour. The ability of the inventive material to degrade with water is generally measured in a water dispersibility test. The test involves placing about 10 grams of the inventive material into 100 ml of water at room temperature in a closed glass container. The container is then inverted and the time is observed until the material disperses. After every minute, the container is inverted. The inventive material of the present invention has a dispersibility time of generally less than 15 minutes with a period of less than 5 minutes and in some inventive embodiments, in a period of less than 2 minutes. The inventive particle provides a delivery system for controlled release granulated camellia seed, other types of granulated seeds, as well as nitrogen, and optional additional agents such as plant nutrients, pesticides, hormones, herbicides, micronutrients, and other additive ingredients.

Numerical ranges cited herein are intended to recite not only the end values of such ranges but the individual values encompassed within the range and varying in single units of the last significant figure. By way of example, a range of from 0.1 to 1.0 in arbitrary units according to the present invention also encompasses 0.2, 0.3, 0.4, 0.5, 0.6, 0.7, 0.8, and 0.9; each independently as lower and upper bounding values for the range.

### Composition of Particles

A particle of the present invention in prototypical form includes a granulated seed meal and a binder component that disperses the constituent granules upon wetting. The particle optionally contains other components depending on the intended action. Such optional components illustratively include an additive ingredient, a plant nutrient, a micro-nutrient, a chelating agent, a secondary vermicide, a pesticide, biochar, bioremedial microbes, and combinations thereof.

As used herein, “seed meal” is defined as granulated camellia seed, granulated mustard seed/leaves that include allyl isothiocyanate, and capsaicin containing granulated seeds such as those of hot peppers.

Without intending to be bound to a particular theory, the aforementioned seed meals contain compounds irritating to round worms. Camellia seed meal contains saponin, a soap/surfactant that acts as an irritant of earthworm mucus membranes. Saponins affect the permeability of the cell membrane in worms and cause vacuolization or disintegration of the earthworm tegument (skin/outer body covering). Saponin content in camellia seed meal is from 3 to 12 total weight percent. Once in contact with the saponins, earthworms vacate the area, often relocating to surrounding areas that are untreated. Similarly, allyl isothiocyanates and capsaicin are irritating to earthworms.

As earthworm castings are only a management issue on low-cut turf areas such as greens, tees, and fairways, thus only these areas are treated with the present invention, leaving the surrounding taller cut turfgrasses untreated and available for earthworm habitation and the beneficial soil reconditioning associated with their presence. Most of the casting problems are caused by non-native, invasive earthworm species, which are currently managed through off-label use of synthetic pesticides that are environmentally detrimental for long term usage.

The present invention is operative in the control of earthworms, in general as well as invasive Asian jumping worms (Amynthas species). Jumping worms alter native soil structure and chemistry by quickly consuming all organic matter, leaving behind a grainy soil full of worm castings. Nutrients in this soil structure can be lost or leached, leaving the soil unable to support native plant life. The soil becomes compacted, more soil erosion occurs, and tree roots become exposed. When forests or plant areas are invaded by jumping worms, plant diversity is greatly reduced, and invasive plant species take over. Currently there are no products on the market for control of jumping worms, even though a safe to use remedy is drastically needed as the jumping worm is continually found in new locations. The inventive seed meal containing particles by dispersing repellant seed meal granules to the shallow root region of soil where such worms are common, control is possible absent the complications of synthetic pesticides.

In a particular application, inventive particles are applied to putting greens to repel worms and their resulting castings. Additional applications of the aforementioned granulated seed meals include treating or creating a barrier to the invasive Asian jumping worm. Additionally, the seed meal particles of the present invention are foodstuffs for shrimp, yet repellent to fish. Without intending to be bound to a particular theory, dissolution/irritation of mucous from fish scales is a possible mechanism of action. As a result, the inventive particles can protect certain aquaculture crops from predation or act as a chemical barrier to deter the further spread of invasive fish species.

The inventive particles are also effective in the usage context of bioremediation. Without intending to be bound to a particular theory, saponins and other components in seed meal make pollutants like polycyclic aromatic hydrocarbons (PAHs), polychlorinated biphenyls (PCBs), and heavy metals less likely to bind to the soil or aquatic silt, and therefore remain more bioavailable. There are three proposed mechanisms: first, the microbial remediation of PAH/PCB containing soil, second, the phytoremediation of heavy metal pollution, and third, simple soil-washing, for which these tea saponins are most effective as a variation between several other washings.

For microbial remediation, microbes used as an additive in the present invention particles or co-administered illustratively includes Bacillus thuringiensis (Bt). For phytoremediation, Boehmeria nivnea is well known to sequester cadmium and does so before at a higher rate with when planted after soil has been treated with inventive particles. In still other embodiments, soil or aquatic silt is treated with inventive particles and then removed and treated through exposure to chelating agents or other chemical techniques such as exchange columns.

The particle contains a binder that produces or promotes cohesion of constituent granules. The binder component is present in amounts ranging from 1% to 95% by weight of the total dry weight of the particle. In still other embodiments, the binder is present in amounts ranging from 1% to 25% by weight of the total dry weight of the particle. Illustrative examples of binders operative herein are carbohydrates such as monosaccharides, disaccharides, oligosaccharides, and polysaccharides; proteins; lipids; glycolipid; glycoprotein; lipoprotein; clays; and combinations and derivatives of these. Specific carbohydrate binders illustratively include glucose, mannose, fructose, galactose, sucrose, lactose, maltose, xylose, arabinose, trehalose, and mixtures thereof such as corn syrup; celluloses such as carboxymethylcellulose, ethylcellulose, hydroxyethylcellulose, hydroxy-methylethylcellulose, hydroxyethylpropylcellulose, methylhydroxyethyl-cellulose, methylcellulose; starches such as amylose, seagel, starch acetates, starch hydroxyethyl ethers, ionic starches, long-chain alkyl starches, dextrins, amine starches, phosphates starches, and dialdehyde starches; plant starches such as corn starch and potato starch; other carbohydrates such as pectin, amylopectin, xylan, glycogen, agar, alginic acid, phycocolloids, chitin, gum arabic, guar gum, gum karaya, gum tragacanth, and locust bean gum;

complex organic substances such as lignin and nitrolignin; derivatives of lignin such as lignosulfonate salts illustratively including calcium lignosulfonate and sodium lignosulfonate and complex carbohydrate-based compositions containing organic and inorganic ingredients such as molasses. Suitable protein binders illustratively include soy extract, zein, protamine, collagen, and casein. Binders operative herein also include synthetic organic polymers capable of promoting or producing cohesion of constituent granules. Binders illustratively include ethylene oxide polymers, polyacrylamides, polyacrylates, polyvinyl pyrrolidone, polyethylene glycol, polyvinyl alcohol, polyvinylmethyl ether, polyvinyl acrylates, polylactic acid, and latex. Clay binders illustratively include montmorillonite and bentonite.

While a seed meal particle according to the present invention has some bioavailable nitrogen to be a N:P:K fertilizer of 1-3:0:0, it is often advantageous to include additional nutrients in an inventive particle. The additional ingredients are present in amounts ranging from 5% to 99.9% by weight of the total dry weight of the particle.

Fertilizers are substances containing one of the plant nutrients nitrogen, phosphate or potassium and illustratively include urea, sulfur-coated urea, isobutylidene diurea, ammonium nitrate, ammonium sulfate, ammonium phosphate, triple super phosphate, phosphoric acid, potassium sulphate, potassium nitrate, potassium metaphosphate, potassium chloride, dipotassium carbonate, potassium oxide, and a combination of these. Soil nutrients illustratively include calcium, magnesium, sulfur, iron, manganese, copper, zinc; oxides thereof, salts thereof, and combinations thereof. Amendment materials are natural organic products such as biochar, humic acid, blood meal, bone meal, seed meal, feather meal and soy meal; meat meal; animal waste from various animal sources; activated sludge, hydrolyzed animal hair; fish byproducts; chitin; composts; and a combination thereof. Biological factors are those factors that have a deleterious effect on a biological organism and illustratively include algicides, bacteriocides, defoliants, desiccants, fungicides, herbicides, insecticides, insect growth regulators, miticides, nematicides, ovicides, pesticides, pheromones, repellents, rodenticides, and a combination thereof. Biostimulants are substances that promote plant survival and health and illustratively include plant growth hormones and plant growth regulators such as cytokinins, auxins, gibberellins, ethylene, absisic acid, and a combination of these. In some inventive embodiments in which the additive ingredient is a fertilizer, soil nutrient or amendment material, the fertilizer, soil nutrient or amendment material are each independently present in an amount ranging from 0.05% to 50% by weight of the total dry weight of the particle.

A chelating agent operative herein is selected to bind a target metal and illustratively includes ethylenediaminetetraacetic acid (EDTA), ethylenediamine-N,N′-disuccinic acid (EDDS), ethyleneglycol bis(2-aminoethylether)-N,N,N′,N′-tetraacetic acid (EGTA), diethylenetriaminepentaacetic acid (DTPA), trans-1,2-diaminocyclohexane tetraacetic acid (CDTA), iminodisuccinate (IDS), nitrilotracetic acid (NTA), or any combination or mixture thereof. Chelating agents are well-suited for heavy metal mediation.

Where the additive is than fertilizer, soil nutrient, or amendment material, these others are each independently present in an amount ranging from 0.05% to 10% by weight of the total dry weight of the particle.

### Method of Making Particles

An inventive particle is formed from seed meal fines that are mechanically aggregated into particles in a pan-granulator in the presence of a binder. The fines of the seed meal typically have a mean granule size that is between 10 and 500 micrometers. In other embodiments, the mean aggregate domain size of the fines is less than 180 micrometers.

The binder is sprayed into the pan granulator with the seed meal fines and other additional materials. The particles are dried and size-screened with particles of desired size being stored for bagging and usage. In some inventive embodiments, the particles are transferred to a coating drum for addition of an additive ingredient or a conditioner material.

In another embodiment, the seed meal fines are mechanically aggregated into pellets in a drum-granulator in the presence of a binder. The fines having the sizes mentioned immediately above.

The binder is sprayed into the drum granulator with the seed meal. The particles are dried and size-screened with particles of desired size being stored for bagging and usage. In some inventive embodiments, the particles are transferred to a coating drum for addition of an additive ingredient or a conditioner material.

In another embodiment, the seed meal fines are mechanically aggregated into pellets in an Eirich unit in the presence of a binder. The fines having the sizes mentioned immediately above.

The binder is sprayed into the drum granulator with the seed meal. The particles are dried and size-screened with particles of desired size being stored for bagging and usage. In some inventive embodiments, the particles are transferred to a coating drum for addition of an additive ingredient or a conditioner material.

Various means of drying the material are available. An exemplary method is fluid bed drying. The material is placed in a fluid bed drier with a drier inlet air temperature that ranges from 120° F. to 220° F. Further methods of drying particles will be apparent to one of skill in the art and illustratively include use of a rotary drum dryer and drying under vacuum conditions.

### Association of an Additive Ingredient with a Particle

An additive ingredient is associated with a particle during the process of particle formation or after particles are formed. For example, an additive ingredient is mixed with the binder. The binder/additive ingredient mixture is added to the seed meal fines and mechanically aggregated in a pan granulator resulting in particles wherein the additive material is in suspension in the binder.

Where it is desirable to add the additive ingredient after particle formation, for example where the additive ingredient is incompatible with suspension in the binder, the additive ingredient is added to the particle following particle formation in the presence or absence of an adhesive. Methods of additive ingredient addition illustratively include spraying onto the particle or adsorption of the additive ingredient by coating the particle in a non-aqueous solution of the additive ingredient.

In another embodiment, the additive ingredient is mixed with an adhesive before application to a particle. An adhesive is a substance that binds to a particle, such that the additive ingredient adheres to the particle in suspension in the adhesive. The adhesive may be the same as the binder or different. The choice of adhesive depends on the particle components and will be evident to one skilled in the art. Examples of adhesives include, but are not limited to, substances listed herein as binder components. Preferably, the adhesive is calcium lignosulfonate, molasses, a liquid corn starch, a liquid corn syrup, or a combination of these.

For example, the additive ingredient in powdered form is adhered to the outside surface of the particle with the use of an adhesive. An adhesive liquid may be used and is applied before or after the addition of the powdered additive ingredient or it may be applied at the same time as the additive ingredient. The choice of adhesive depends on the particle components and will be evident to one skilled in the art. Examples of a liquid adhesive include but are not limited to binders listed herein, including mineral oils or polymer liquids such as polybutene.

### Durability of Particles

The particles of the present invention have a minimum Resistance To Attrition (RTA) rating ranging from 60% to 100% as determined by the method detailed in Example R or an art-recognized equivalent procedure.

### Size of Particles

The particles of the present invention have a mean particle domain size that ranges from 0.1 millimeter to 30 millimeters. More preferably, the mean particle domain size ranges from 0.25 millimeter to 20 millimeters. Still more preferably, the mean particle domain size ranges from 0.50 millimeter to 15 millimeters. The particles formed by the process of the present invention have a Uniformity Index rating in the range of 30 to 60 where the Uniformity Index rating is calculated as the 10^{th} percentile particle size expressed as a percentage of the 95^{th} percentile particle size.

### Shape of the Particles

Particles of the present invention take any shape illustratively including spheres, cylinders, ellipses, rods, cones, discs, needles, and irregular. In some inventive embodiments, such as those in which a pan agglomerator is used, the particles are approximately spherical.

### Method of Use

The particles of the present invention are broadcast to produce a desired effect. Particles are administered by a method which delivers the particles to a target area of turf, or water. A rotary spreader works well in either usage setting. The particles are then dispersed into constituent granules by water which is user-applied or natural such as rain, dew, or atmospheric humidity.

In another embodiment, the particles are placed under the soil surface or in furrows or bore holes.

The present invention is further described with respect to the following non-limiting examples. These examples are intended to illustrate specific compositions according to the present invention and should not be construed as a limitation as to the scope of the present invention.

### EXAMPLE 1

Dispersible granulated camellia seed particle preparation: Using a pan agglomeration disk, 4% of a binder such as calcium lignosulfanate, corn starch, and corn syrup, is applied to a remainder that is a mixture of fines of granulated camellia seed, other types of granulated seeds (material less than 250 microns). The agglomeration disk is operated and adjusted to generate the desired size distribution of particles before the particles are conveyed to a fluid bed drier where the material is dried at a temperature of 140° F. to a moisture content of less than 0.5%. The material is then separated into various size categories using conventional gyroscopic screeners. General size of these product streams are as follows, 3,360 microns and larger, from 3,360 microns to 1,191 microns, from 1,191 microns to 594 microns, and material smaller than 594 microns. The range of sizing for each product stream can be varied to separate the desired material from the mixture of sizing. The resulting dispersible particles have a N:P:K of 1-0-0. Resistance to Attrition is 80%.

### EXAMPLE 2

The process of Example 1 is repeated with 5-20% potash replacing a like amount of granulated camellia seed meal to produce a particle with N:P:K of 1:0:5-20.

### EXAMPLE 3

The process of Example 1 is repeated with biochar replacing various amounts of granulated camellia seed meal to produce particles with similar physical properties to those of Example 1.

### EXAMPLE 4

Inventive particles are tested as to a combinatorial effect with biochar per Examples 1 and 3. A greenhouse used for the trial is air conditioned to prevent that heat added to mortality. A commercial organic potting mix with added mycorrhizae is added to 22 cm diameter pots. Each pot received 7 adult Asian jumping worms. Treatments are replicated 15 times. Table 1 shows the treatments. The alternative saponin treatments are shown here as a comparative example with the effectiveness of the biochar and saponin treatments. Comparative Example A per ton included 1622 pounds of tea seed meal powder and 378 pounds of lignin binder. Comparative Example B per ton included 1,143 pounds 14-0-0 Lysine, 339 pounds 13% Iron EDTA powder, 34 pounds 0-0-62 potassium chloride, 423 pounds pelletized limestone, 60 pounds dextrin powder, and 1 lb. of dust control agent. The Comparative Example B components granulated with water and absent a binding agent.

TABLE 1
Vermicidal efficacy of inventive composition with vary amounts
of biochar and compared to conventional saponins

| | Amount per | Amount (lbs/ |
|---|---|---|
| Treatment | pot [g] | 1000 sqft) |
| Biochar | 2.4 | 10 |
| Biochar + saponin | 2.4 | 10 |
| Biochar + saponin | 3.4 | 15 |
| Biochar + saponin | 4.4 | 20 |

| | |
|---|---|
| Comparative Ex. Alternative | Drench, |
| saponin A | |
| Comparative Ex. Alternative | drench |
| saponin B | |
| Control nothing added | n/a |

The trials are run for four weeks from mid-August to mid-September.

After four weeks the media in each pot are hand sorted and examined for number of surviving earthworms, N. Mortality was calculated in two ways. First, mortality is calculated as the percent mortality for each pot as

$$M 1 = \frac{7 - N}{7}$$

Second, Abbott mortality, which is adjusted for the mortality in the control, is calculated as

$${M}_{A} = \frac{M 1 - M 1 c}{M 1 c}$$

where M1c is the mortality calculated for the control treatment.

Additionally, the number of pots with no surviving earthworms, Po, at the end of the four week incubation period is noted.

Table 2 shows the mortality measures for the treatments. There is a clear effect of the amount of saponin on Asian jumping worm mortality. M1 increases from 55% for the 2.4 g/pot biochar/saponin treatment to 82% for the 4.4 g per pot treatment. There is no significant difference between the 2.4 biochar and the 2.4 g of biochar/saponin combination, suggesting that the biochar does not have an effect. Only the 2.4 and 3.4 g of biochar/saponin treatments and the conventional comparative combinations are killing earthworms above the control mortality rate (MA), and thus effective in killing the earthworms. This is also reflected in the number of pots, Po, that had no survivors in it. The tea tree derived saponin performs better than the coconut derived saponin drench of Comparative Example A. Comparative Example A per ton included 1622 pounds of tea seed meal powder and 378 pounds of lignin binder.

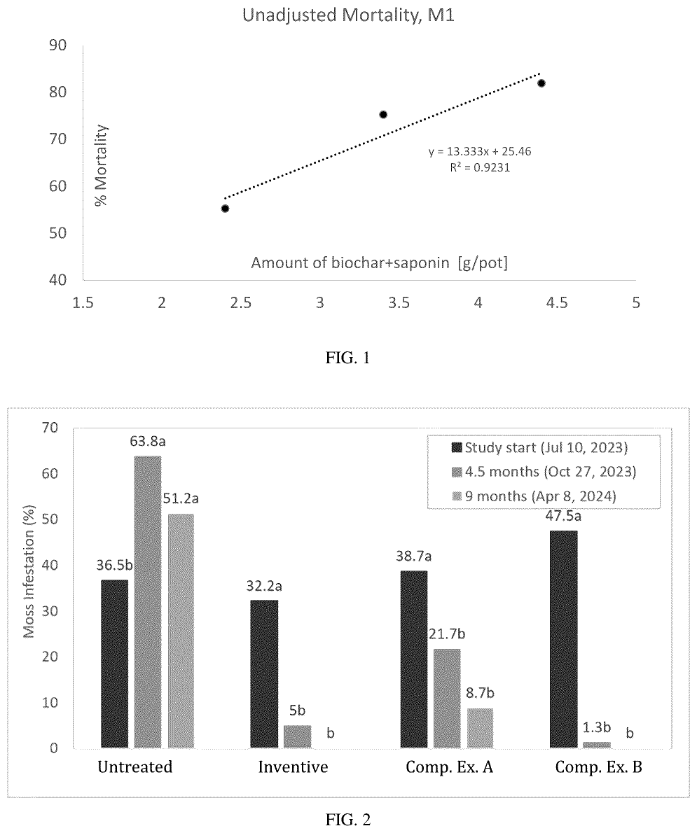

TABLE 2
The dose response relationship between the biochar/saponin amount
added and M1 mortality is linear as shown in the FIG. 1. -
Mortality of earthworms and number of pots with no survivors
in biochar and tea tree treatments is also provided.

| | Amount per | Effect [%] | | |
|---|---|---|---|---|
| Treatment | pot [g] | M1 | M_{A} | Po out of 15 |
| Biochar | 2.4 | 52 | −47 | 0 |
| Biochar + saponin | 2.4 | 55 | −38 | 1 |
| Biochar + saponin | 3.4 | 75 | 24 | 4 |
| Biochar + saponin | 4.4 | 85 | 44 | 5 |
| Comparative Ex. | drench | 43 | −74 | 0 |
| Alternative saponin A | | | | |
| Comparative Ex. | drench | 73 | 18 | 2 |
| Alternative saponin B | | | | |
| Control nothing | NA | 67 | 0 | 0 |
| added | | | | |

From these trials show that the saponin present in the inventive dispersible particles is an effective substance in the combination with biochar.

### EXAMPLE 5

The inventive dispersible particles of Example 1 are broadcast on a half of a putting green at 3-5 lbs per 1,000 sq ft. The particles are watered with approximately 0.25″ of water within 12-24 hours after application to avoid mower pick-up. Irrigation or rainfall disperse each particle into thousands of smaller constituent granules, moving the product into the soil for improved product efficacy and decreased mower pick-up. This allows for less water needed to incorporate the product into the root zone, thus less chance of product running off into untreated areas. As Comparative Example C, a commercial tea seed meal that is 15% by weight saponin and made from the residue of tea seeds after camellia oil extraction is spread on the other half of the green in crumb form at the recommended amount of 6-12 lbs per 1,000 sq ft. The Comparative Example C required roughly twice the water to disperse and have a comparable effect in controlling worm casting, as measured after one week, yet with higher loadings.

### EXAMPLE 6

The process of Example 1 is repeated with micronutrients (such as iron sulfate or manganese oxide), soil amendments (such as humic acid materials), or biostimulants replacing a like amount of granulated camellia seed to produce particles with similar physical properties to those of Example 1.

### EXAMPLE 7

The process of Example 1 is repeated with 1-10 weight % ground cayenne pepper replacing various amounts of granulated camellia seed to produce particles with similar physical properties to those of Example 1.

### EXAMPLE 8—RESISTANCE TO ATTRITION DETERMINATION

Apparatus: Ro-Tap sieve shaker with 8-inch sieves, balance with 0.1 g sensitivity, 10-min timer, and 10 steel balls with smooth surfaces and 16 mm (⅝ in.) in diameter.
1. Using information from the Screen Analysis, choose your limiting screen size. The following table 3 indicates the limiting screen for several fertilizer blends.

TABLE 3
Limiting screen for several fertilizer blends.

| Fertilizer Sizing | U.S. (Tyler) |
|---|---|
| Coarse | 16 (14) |
| Premium Standard | 20 (20) |
| Fairways | 20 (20) |
| Greens | 30 (28) |

2. Place about 75 g of a representative sample onto the limiting screen.
3. Reassemble the screen apparatus with the limiting screen just above the pan.
4. Place the screen apparatus onto the shaker and run it for 10 min (Use the hammer).
5. Empty the pan. Transfer 50.0 g of sample to the pan.
6. Put ten (10) 16-mm steel balls in the pan with the sample.
7. Reassemble the screen apparatus and place it onto the shaker and run it for 10 min (Do not use the hammer).
8. Remove the steel balls from the pan and transfer the sample back into the limiting screen.
9. Place the screen apparatus back onto the shaker and run it for 10 min (Use the hammer).
10. Weigh out the amount that remained on the limiting screen to the nearest 0.1 g and compare it to the original amount.

Percent resistance to attrition={(100·a)/b}, where a is the weight of the fraction that remained on the limiting screen in Step 10 and b is total weight of the sample in Step 5.

### EXAMPLE 9—MOSS CONTROL ON A GOLF COURSE WITH GRANULAR BASED HERBICIDE

Treatments for a moss control in a comparative study were carried out at a golf course on a turfgrass of creeping bentgrass L-93 plus SR1119 and Poa annua (two species estimated at 80-90% bent and 10-20% Poa). Eight applications of inventive embodiments of the water dispersible granule in comparison with a spray liquid application were applied over a period from July 10 through Oct. 13, 2023 at a site with a history of silvery thread moss infestation.

TABLE 4
Treatments for a moss control Study at a golf course

| | | | | 8 App Dates@14 |
|---|---|---|---|---|
| Treatment | Fungicide Rotation Detail | Rate | Formulation | day intervals |
| 1 | Untreated | n/a | n/a | none |
| 2 | Ex. 1 | 6.7 fl oz/Acre | liquid | Jul 10, Jul 24, |
| 3 | Comparative Ex. A | 15 lbs/1000 sq ft | granular | Aug 7, Aug 21, |
| 4 | Comparative Ex. A + EXT998 | 15 lbs/1000 sq ft | granular | Sep 5, Sep 18, |
| 5 | Comparative Ex. A + EXT1558 | 15 lbs/1000 sq ft | granular | Oct 2, Oct 13 |
| 6 | Comparative Ex. B | 6 lbs/1000 sq ft | very fine granular | |

Weekly visual quality from Jul 10 to Oc 27 was recorded based on Normalized Difference Vegetation Index (NDVI) using GreenSeeker/Trimble HCS-100 where visual quality was rated on a 1-9 scale, with 6=minimum acceptable and 9=best. Acceptable quality (≥6.0) occurred with Comparative Ex. B on 9 dates out of a total of 16 rating dates (56%) after initial application. No other treatment saw acceptable quality due to heavy moss pressure. Best quality by Comparative Ex. B was influenced by two aspects: moss suppression and greener turf color (via Fe and N fertility).

Weekly NDVI of treatments from Jul 10 to Oct 27 and a final summary by area under the progress curve (AUPC). AUPC was statistically different by Fisher's LSD (P<0.05). NDVI saw similar trends as visual quality. NDVI tended to be lowest in Ex. 1 which periodically appeared off color due to phytotoxicity. Phytotoxicity was observed in Comparative Ex. A+EXT998 and Comparative Ex. A+EXT1558 on Jul 17 where EXT998 and.EXT1558 are supplemental nematacides. Effects in Untreated, Comparative Ex. A and Comparative Ex. B were solely due to presence of moss or turf color.

Based on Moss AUPC analysis, only two treatments were able to consistently control moss compared to untreated. Best control was by Quicksilver and Comparative Ex. B and both provided similar control across the study period. Daily rating data showed Comparative Ex. A performance was best in the fall, a time when moss pressure naturally increases.

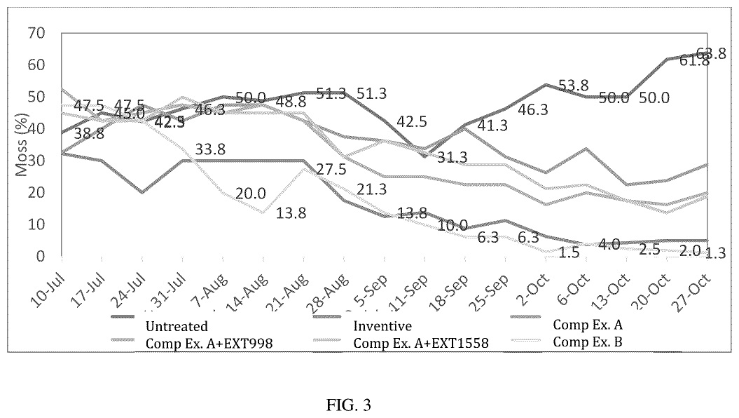

As shown in FIGS. 2 and 3 areas treated with inventive embodiments achieved marked control of silvery thread moss, whereas untreated areas saw an increase in silvery thread moss. FIG. 2 is a comparative bar graph showing moss infestation percentage at study start, 4.5 months, and 9 months for untreated control and for quicksilver, Comparative Ex. A, and Comparative Ex. B formulations. FIG. 3 is a line graph of moss infestation percentage at study start and at 14 day intervals during the period of the study from July 10 to October 13 for untreated control and for quicksilver, Comparative Ex. A, and Comparative Ex. B formulations.

Any patents or publications mentioned in this specification are indicative of the level of those skilled in the art to which the invention pertains. These patents and publications are herein incorporated by reference to the same extent as if each individual publication was specifically and individually indicated to be incorporated by reference.

One skilled in the art will readily appreciate that the present invention is well adapted to carry out the objects and obtain the ends and advantages mentioned, as well as those inherent therein. The present methods, procedures, treatments, molecules, and specific compounds described herein are presently representative of preferred embodiments, are exemplary, and are not intended as limitations on the scope of the invention. Changes therein and other uses will occur to those skilled in the art which are encompassed within the spirit of the invention as defined by the scope of the claims.

1. A water-dispersible particle comprising:
a granulated seed meal;
a binder component, present in an amount ranging from 1% to 95% by weight of the total dry weight of the particle, the particle having a mean particle domain size; and
wherein the seed meal and the binder component are present in a form such that contact with water causes particle dispersion into more than 100 pieces in a time period of up to 24 hours.

2. The particle of claim 1 further comprising biochar.

3. The particle of claim 1 further comprising microbes.

4. The particle of claim 1 further comprising a bioavailable fertilizer, a micronutrient, or a combination thereof.

5. The particle of claim 1 wherein the time period is 1 second to 1 hour.

6. The particle of claim 1 further comprising an additive ingredient.

7. The particle of claim 6 wherein the additive ingredient is a soil nutrient of: calcium, magnesium, sulfur, iron, manganese, copper, zinc; oxides thereof; salts thereof; or a combination thereof.

8. The particle of claim 6 wherein the additive ingredient is a natural organic product of: humic acid, blood meal, bone meal, seed meal, feather meal, soy meal, meat meal, animal waste, activated sludge, hydrolyzed animal hair, a fish byproduct, chitin, composts, or a combination thereof.

9. The particle of claim 1 wherein water causes particle dispersion into between 1,000 and 10,000 pieces and the mean particle domain size ranges from 0.1 millimeter to 30 millimeters.

10. The particle of claim 1 wherein the seed meal is camellia seed meal.

11. The particle of claim 10 further comprising as an additional material one or more of mustard seed meal, cayenne pepper, or saponin.

12. The particle of claim 1 wherein the seed meal is mustard seed meal.

13. A water-dispersible particle comprising:
a granulated camellia seed meal present in an amount ranging from 5% to 99% by weight of the total dry weight of the particle, alone or in combination with biochar;
a binder component, present in an amount ranging from 1% to 95% by weight of the total dry weight of the particle, the particle having a mean particle domain size;
the granulated camellia seed present in a form such that contact with water causes particle dispersion into more than 100 pieces in a time period of up to 24 hours.

14. The particle of claim 13 further comprising one or more of biochar, microbes, a chelating agent, or a micronutrient.

15. The particle of claim 13 further comprising an additive ingredient that comprises a soil nutrient selected from the group consisting of: calcium, magnesium, sulfur, iron, manganese, copper, zinc; oxides thereof; salts thereof, and a combination thereof.

16. A method of repelling round worms from turf comprising:
broadcasting particles of claim 1 on or around a perimeter of the turf; and
exposing the particles to water in an amount sufficient to induce dispersion of the particles to constituent granules, the granules repelling the round worms from the turf.

17. The method of claim 16 wherein the particles are broadcast in an amount of from 1 to 5 pounds per 1000 square feet.

18. The method of claim 16 wherein the round worm is an Amynthas species.

19. A method of bioremediation comprising:
broadcasting particles of claim 1 on soil or aquatic silt containing a contaminant;
exposing the particles to water in an amount sufficient to induce dispersion of the particles to constituent granules to inhibit sequestration of the contaminant; and
treating the soil or aquatic silt to concentrate the contaminant.

20. The method of claim 19 wherein the treating includes at least one of: applying a chelating agent, microbes, or growing Boehmeria nivnea in proximity to the contaminant.
